(19) United States
(12) Patent Application Publication
(10) Pub. No.: US 2018/0122266 A1
(43) Pub. Date: May 3, 2018

(54) PROGRAMMABLE LANGUAGE TEACHING SYSTEM AND METHOD

(71) Applicants: Kaveh AZARTASH, Aliso Viejo, CA (US); Dhonam PEMBAH, Irvine, CA (US)

(72) Inventors: Kaveh AZARTASH, Aliso Viejo, CA (US); Dhonam PEMBAH, Irvine, CA (US)

(21) Appl. No.: 15/344,162

(22) Filed: Nov. 4, 2016

Related U.S. Application Data
(60) Provisional application No. 62/416,604, filed on Nov. 2, 2016.

(51) Int. Cl. G09B 19/06; A63H 3/02; A63H 3/00; A63H 3/28; G09B 5/04

(52) U.S. Cl. CPC G09B 19/06; A63H 3/02; A63H 2200/00; A63H 3/28; G09B 5/04; A63H 3/003

(57) ABSTRACT

This invention concerns interactive language learning methods and systems. These interactive systems and methods include an interactive unit, for example, a toy that includes a processor running a language learning application, an output device, e.g., a speaker, to communicate with the learner, a learner input device, e.g., microphone to receive input from the learner, a server running learning software, and, in preferred embodiments, a mobile device configured to control the toy settings. In operation, a user (e.g., the learner's parent) selects the native language used to the unit/toy and initially interacts with the learner (e.g., a child) in the same language. After assessing the learner's native language knowledge, the unit/toy begins interacting with the learner in a second (i.e., non-native or foreign) language selected by the user. The system then exposes the learner to sounds, then syllables and words before gradually progressing to phrases and sentences, followed by stories, assessments, and tasks. In this way the invention will better assist learners, especially children, in learning new languages.

### CROSS REFERENCE TO RELATED APPLICATION

This application claims the benefit of and priority to U.S. provisional patent application Ser. No. 62/416,604 (attorney docket number KAD-0100-PV) filed 2 Nov. 2016, the contents of which are hereby incorporated by reference in their entirety for any and all purposes.

### TECHNICAL FIELD

The present document relates to interactive system-assisted language learning processes and, in particular, to interactive units and related devices to assist language learners, particularly children, in learning one or more non-native languages.

### BACKGROUND OF THE INVENTION

### 1. Introduction

The following description includes information that may be useful in understanding the present invention. It is not an admission that any such information is prior art, or relevant, to the presently claimed invention, or that any publication specifically or implicitly referenced is prior art.

### 2. Background

Knowing multiple languages and having the ability to communicate in those languages provides great advantages in today's fast growing world. Today, different people from different cultures, ethnicities, and/or nationalities routinely interact professionally, casually, and otherwise and geographical barriers are hardly considered as a limitation. It is a well researched and accepted fact that learning new languages at a younger age tends to influence children in a positive way.

Traditionally, language experts teach people to learn one or more non-native languages in a classroom environment, which is time consuming and often not particularly enjoyable. Children are even less attracted toward structured, non-enjoyable ways of learning. Also, classroom teaching of language to children has a lot of disadvantages. Firstly, the content of the books used for teaching is fixed and children find it very difficult to understand languages, comprehend the flow of conversations, etc. Moreover, books tend to carry limited or no exercises that explain or contextualize each specific word or phrase, and hence students find it next to impossible to difficult to develop fluency in a new language.

Given such problems, various methods have been developed that partially overcome such drawbacks. In many of these instances, language learning is carried out through an interactive device. Typically, such systems allow user to interact with the interactive device, which interacts in one language at a time. Such methods would not look interesting to children, however, as there is no comparison of the language being learned to the learner's native language(s).

In order to ensure that language learning is made easy, interactive, more effective, and enjoyable, this invention provides methods and systems that utilize an interactive toy to provide non-native language instruction. Preferably, such toys can understand and communicate with language learners, particularly children, in multiple languages, including the learner's native language(s).

### 3. Definitions

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

An “application” is a computer program (i.e., a set of instructions to perform a specific task when executed by a computer) that performs a group of coordinated functions, tasks, or activities for the benefit of the user. A part of a computer program that performs a well-defined task is known as an algorithm. A collection of computer programs, libraries, and related data are referred to as software. Applications are usually implemented as software. Examples of applications include word processors, spreadsheets, web browsers, media players, and games. Application software typically refers to a collection of applications, whereas system software refers to computer programs such as operating system software (which runs the computer), utilities (which perform maintenance or general-purpose tasks), and programming tools (which are used to write computer programs).

An “artificial intelligence engine” refers to machine learning.

A “computer” is a general-purpose device that can be programmed to carry out sets of arithmetic or logical operations automatically. Since the device can carry out different sequences of operations depending on the programming then being acted upon, a computer can solve more than one kind of problem. A computer generally has at least one processing element, typically a central processing unit (CPU), one or more forms of memory, a power supply, and the circuitry necessary to operably connect the various components and any intended peripheral device(s), as well as the circuitry and components necessary to allow the computer's connection to a computer network. The CPU carries out arithmetic and logic operations, and a sequencing and control unit can change the order of operations in response to stored information. Peripheral devices (i.e., input or output devices used to put information into or get information out of a computer, e.g., keyboards, computer mice, touchscreens, barcode readers, image scanners, digital still or video cameras, microphones, game controllers, displays, printers, projectors, audio speakers, etc.) allow information to be retrieved from an external source, and the result of operations saved and retrieved.

A “computer network” refers to a telecommunications network that allows computers to exchange data. In such networks, networked computers (or other computing devices (e.g., mobile phones, tablet computers, servers, etc.)) exchange data with one or more other computers (nodes) in the network via a data link. Connections between nodes are established via cable and/or wireless connections. Examples of cable networks include those that utilize transmission lines, optical fiber, and the like. Examples of wireless networks (i.e., those wherein information can be transferred between two points, often by radio, light, magnetism, electric fields, or sound, that are not connected by an electrical conductor) include cell phone networks, wireless local networks, satellite communication networks, and terrestrial microwave networks. Networked computer devices that originate, route, and terminate the data are called nodes, which can include personal computers, smart mobile phones, servers, and other networking hardware.

The terms “displaying”, “causing to be displayed”, and analogous expressions refer to taking one or more actions that result in displaying information to a user. For example, a server computer may cause a web page to be displayed by making the web page available for access by a client computer over a network, such as the Internet, which web page the client computer can then display to a user, typically via an output device such a computer monitor or screen, the touchscreen of a mobile device (e.g., a smartphone or tablet computer), etc. A toy may also display information to a user, for example, via a computer monitor or other screen integrated as part of the toy and visible to a user.

In this document, the words “embodiment,” “variant,” “example,” and similar expressions refer to a particular apparatus (or machine or system), process (or method), or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” or “representative” means that the item is used as a non-limiting example. Such characterization of an embodiment does not necessarily mean that the embodiment is a preferred embodiment; the embodiment may but need not be a currently preferred embodiment. All embodiments are described for illustration purposes and are not limiting unless otherwise specifically noted.

A “learner engine” refers to an algorithm that keeps track of learner's input and performance using the invention, thus allowing the correct level of conversation or interaction between the learner and interactive unit to be called by the interactive unit. A speech to text converter is preferably used to convert verbal input from the learner to text form. Speech or other sounds from the learner is/are preferably detected by one or more microphones disposed in the interactive unit. Of course, in some embodiments, learner input can be made using another input device, for example, a keyboard, a camera (e.g., to analyze sign language), or other suitable device. The learner input data is then analyzed to determine its level, stage, correctness, etc. These results are then used by the processor to select from the associated database(s) to select the appropriate response, e.g., the appropriate sound, phrase, or sentence engine to produce the appropriate output. In some embodiments, the text can be processed with a natural language classier to help the learner engine identify the meaning of the input.

A “learner” refers to a person who takes language-learning sessions from the interactive unit and user refers to a person who controls the interactive unit through a user device. In some cases learner and user may be the same person.

“LMS” refers to a learning management system, which is a software application for the administration, documentation, tracking, reporting, and delivery of electronic educational technology.

A “patentable” composition, process (or method), machine (or system), or article of manufacture means that the subject matter satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically excludes the non-patentable embodiment(s). Also, the claims appended hereto are to be interpreted both to provide the broadest reasonable scope, as well as to preserve their validity. Furthermore, the claims are to be interpreted in a way that (1) preserves their validity and (2) provides the broadest reasonable interpretation under the circumstances, if one or more of the statutory requirements for patentability are amended or if the standards change for assessing whether a particular statutory requirement for patentability is satisfied from the time this application is filed or issues as a patent to a time the patentability or validity of one or more of the appended claims is questioned.

A “personal computer” (e.g., a student computer) is a general-purpose computer whose size, capabilities, and price make it useful for individuals, and can be operated directly by an end-user (e.g., a student) without an intervening computer. Software applications for personal computers include word processors, spreadsheets, databases, web browsers, e-mail clients, digital media players, games, and personal productivity and special-purpose software applications. In the context of the invention, a personal computer will have an Internet connection to allow WWW access. Personal computers can be connected a local area network (LAN) or wide area network (WAN), either by a cable or a wireless connection. A personal computer may be, for example, a laptop computer or a desktop computer running an operating system such as Windows (Microsoft Corp.), Linux, or Macintosh OS (Apple).

A “phrase engine” refers to software that determines the sequence of phrases to be output by the interactive unit based on learner level and user input.

A “plurality” means more than one.

A “server” is software or a computing device that provides functionality for other programs or devices, termed clients. In a client-server architecture, a single overall computation, series of computations, or processes may be distributed across multiple processes or devices. Servers can provide various functionalities, often called “services”, such as sharing data or resources among multiple clients, or performing computation(s) for a client. A server can serve multiple clients, and a client can use multiple servers. A client process may run on the same device or may connect over a network to a server on a different device. A server is often more powerful and reliable than a standard personal computer, although large computing clusters composed of many relatively simple, replaceable server components can also be used as servers.

A “sentence engine” refers to software that determines the sequence of sentences to be output by the interactive unit based on learner level and user input.

A “sound engine” refers to software that determines the sound, or sequence of sounds and/or words, to be output by the interactive unit based on learner level and user input.

### SUMMARY OF THE INVENTION

Accordingly, the invention provides interactive systems and methods for language learning. These systems include an interactive unit that includes a computer, a speaker, a microphone, a power supply, and componentry that allows the unit to electronically communicate, be it wirelessly or via a physical connection, with other system components, which include a server in communication with the interactive unit. In preferred embodiments, the system also includes a user device (e.g., a dedicated remote control device; a smartphone, personal computer, tablet computer, or the like running an interactive unit control application (or “app”), etc.) configured to control the interactive unit settings, although in some embodiments, the interactive unit further includes componentry that allows a supervisory user, for example, a child's parent or guardian, a child's teacher, or, in some embodiments, the learner her/himself, to adjust the interactive unit's settings directly.

In operation, the interactive unit is loaded with the learner's native language as per the instructions from the user device and interacts with a learner in that language. After assessing the learner's level of native language knowledge, the interactive unit begins interacting with the learner in a second, preferably non-native language, which is again as per the instructions provided to the interactive unit from the user device (or, if user device functionality is integrated into the interactive unit, via the settings input into the unit via a suitable user input device or interface). The flow of conversation starts by exposing the learner to sounds, then syllables, then words, and gradually to phrases and sentences. This flow is preferably further followed by stories, proficiency assessments, and tasks. In this way, the systems and methods of the invention assist learners, particularly children, in learning new languages.

Various features and advantages of the invention will appear from the following description in which the preferred embodiments have been set forth in detail in conjunction with the accompanying drawings.

### BRIEF DESCRIPTION OF THE DRAWINGS

In this specification, reference will be made in detail to several embodiments that are illustrated in the accompanying drawings. In the drawings, the same reference numerals and corresponding descriptions are used to refer to the same apparatus elements and method steps. The drawings are in a simplified form, not to scale, and omit apparatus elements and method steps that can be added to the described systems and methods, while possibly including certain optional elements and steps.

FIG. 1 is an illustrative embodiment of a flow diagram that depicts the various steps of the method described herein

FIG. 2 is an illustrative embodiment that depicts the various modules of the system described herein.

FIG. 3 is an illustrative embodiment that depicts the method of working of an interactive unit, server and user device with respect to present invention.

FIG. 4 is an illustrative embodiment of a flow diagram that depicts the various steps involved in learning a new language.

FIG. 5 is an exemplary embodiment that depicts the flow of conversation of interactive unit.

### DETAILED DISCRIPTION OF THE INVENTION

### Detailed Description

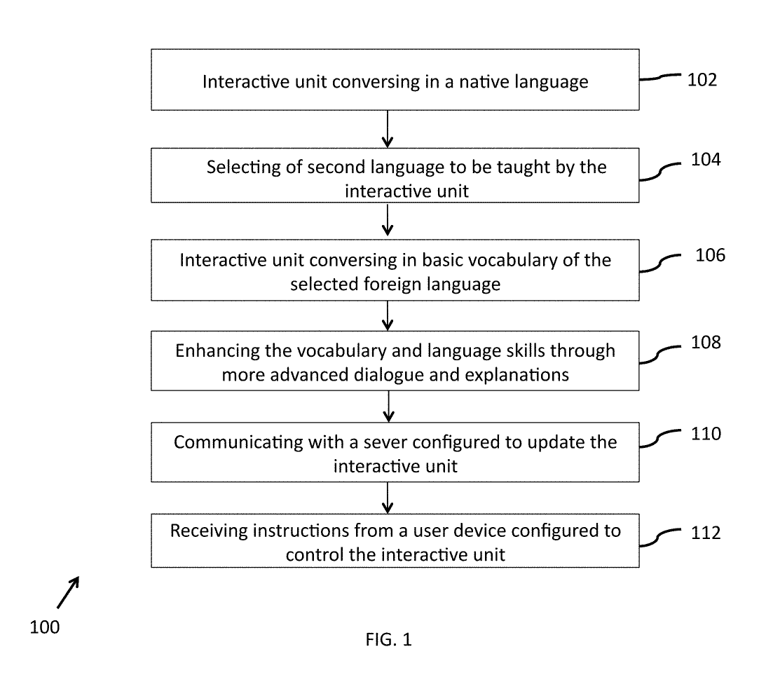

In the following detailed description, reference is made to the accompanying drawings (FIGS. 1-5), which form a part hereof. In the drawings, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented here.

The invention concerns a multi-component system that comprises an interactive unit, a server, a learning application, and in preferred embodiments, a mobile device to control and configure the interactive unit. However, the system is not limited to these components. For example, the mobile device could be a computer, a smartphone, or any other component. Also, the components could be integrated into a single device, for example, a software application running on a computer. In the representative embodiment described below, the system includes a mobile device connected to a toy, each of which is connected to or is capable of interacting with (e.g., a wireless connection) a server. As will be appreciated, the server could be local and, in some embodiments, could even be integrated as part of the same component (e.g., as part of the interactive unit). The location and type of medium is irrelevant, it generally means there are three hardware components to the system: the actual human/learner interface device, e.g., a toy; software or computer; the server, which stores the data and algorithms for adapting the conversation, etc.; and the software or interface that allows management of the human/learner interface, which could be an app, or other device capable of managing settings on the interactive human/learner interface device.

In operation, the learner interacts with the interactive unit, which can be configured via software to acknowledge correct and incorrect responses. The software also configures the processor to react to those responses by selecting from the associated database how to move the dialogue and conversation forward, e.g., to reinforce existing learning and/or introduce new concepts, or backward, e.g., to review previous material, revert to an earlier learning stage, etc. The interactive unit responds to the learner's input by providing positive or negative feedback. The feedback can be any visual, auditory, tactile, or other sensory output that the child/user could experience to provide positive or negative feedback from the interactive unit. Feedback examples include playing music, flashing lights, movement (e.g., hand-clapping, vibration), etc.

The system includes components for storing learner data and user input, receiving score for the data in categories, identifying learners and users, comparing data, and setting thresholds for assessing progress and tracking progress using thresholds. Thus, for example, a parent can look at the learner management system to identify words, phrases, and sounds that a child has learned, mastered, or is struggling with. The parent (or guardian), or the system itself if so configured, can identify where in a curriculum or at what level of progress a child is, and compare those results to the learner's past performance or comparatively against other learners. The system can also include a learning management system for use in tracking learner progress and/or evaluating learner performance with respect to selected comparative norms.

### Representative Embodiments

The following descriptions illustrate several preferred exemplary embodiments of the invention by reference to the accompanying drawings. The embodiments herein and the various features and advantageous details thereof are explained with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the scope of this patent application should not be construed as limited to the illustrative embodiments.

The interactive systems and methods for language learning are specifically designed to assist people, particularly children (each a “learner”) in learning new languages. The system includes an interactive unit having a processor, a speaker, and a microphone, a server in communication with the interactive unit, and a user device configured to control the interactive unit settings. To use the system, a user (e.g., a child-learner's parent or guardian) uses her/his mobile device to configure starting settings on the interactive unit, including, for example, selecting a native language for the unit. As a result, the interactive unit will use that setting to interact with the learner as appropriate in the learner's native language. For example, the interactive unit may begin teaching a new language to the learner after first assessing the learner's native language knowledge or proficiency. Based on those results, the system may automatically adjust the level and/or type of learning best-suited to assist the learner in acquiring proficiency in a new, non-native language, after which the interactive unit may start interacting with the learner in the new language selected by the user (who may or may not be the learner).

FIG. 1 is an illustrative embodiment of a flow diagram 100 that depicts the language learning methods described herein. Here, the method for interactive language learning includes an interactive unit that may be any device with a processor, microphone, speaker, memory, and a specified learning engine. Firstly, the interactive unit is allowed to interact with a learner in a native language 102. The native language selection is pre-stored in the interactive device and can be changed at any point using a user device. The user device can be any mobile device with different operating system including, but not limited to, Android, Bada BlackBerry OS, iPhone OS/iOS, MeeGo OS, Palm OS, Symbian OS, webOS, or any other OS known in the art or developed in the future. The interactive unit starts conversing in the learner's native language (i.e., that language so selected by a user) and to assess the learner's native language knowledge level, preferably with the help of artificial intelligence, and then gradually initiates interaction with the learner in the selected “second” language (i.e., the language to be learned) in order to teach the learner the second language.

After the second language selection, the interactive unit starts interacting with the learner by initially exposing him/her to sounds and syllables and then gradually to words and phrases that can be considered as basic vocabulary 106. Once the learner is familiar with the conversational repository of the second language, he/she is next exposed to more advanced dialogues and explanations 108.

To explain the process in a different way, consider the example of a child who initially talks to the interacting unit in her/his native language and then gradually a second language is introduced. The protocol used to facilitate the child's learning of this new language is to expose her/him first to sounds, syllables, and then gradually to words. Once the child is more comfortable with the words, combinations of words are taught, starting with simple phrases. Gradually, the program moves on to stories, tasks, dialogues, explanations, and more complicated tasks and examples relayed to the learner in the second language. In preferred embodiments, the child's progress is monitored and recorded. Analysis of the child's learning progress can be conducted periodically, for example, automatically at predefined intervals set by the user, on an ad hoc basis, as may be determined by the user (or learner), etc.

Throughout the process, the interacting unit 110 communicates with a server 212 configured to update a database stored in a memory 308 of the interactive unit 110 on a continuous or periodic basis with a repository of sounds, words, phrases, sentences, stories, etc. in the second language. The communication may be carried out wirelessly, for example, using Wi-Fi, Bluetooth, Zigbee, or any other wireless communication protocol and associated hardware and software now known in the art or developed in the future. Further, as illustrated in block 112 of FIG. 1, the interactive unit 110 is in contact with a user device 210 configured to control the interactive unit 112. In preferred embodiments, the user device 210 includes a mobile application that requires the creation of a user profile and the setting of user preferences for the native and second languages to be learnt, the pace of learning, and such other preferences as the app developer may desire.

In alternative embodiments, the functionalities of the user device 210 and the interactive unit 110 may be combined or integrated in a single device (not shown) that can be used in accordance with the invention by both learners and users, both to assist the learner(s) in learning a new language and to facilitate a user's setting of preferences for the native and second language components of the system, the learner's pace of learning etc.

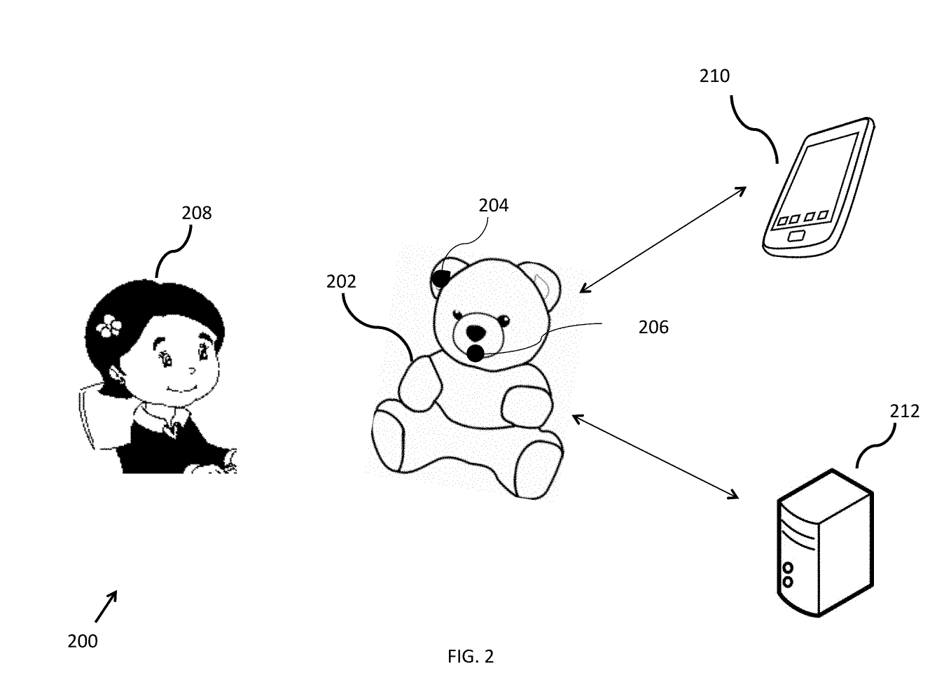

FIG. 2 shows an illustrative embodiment 200 that depicts the various modules of an interactive system for language learning according to the invention. In this embodiment, the system 200 includes an interactive unit, e.g., a toy, 202, a server 212 wirelessly connected to the toy 202, and a user mobile device 210 configured to control the toy 202. A learner 208 may interact with the toy 202 through a microphone 204 and a speaker 206. The toy 202 starts conversing with the learner 208 in her native language. Depending on the learner's replies, the toy judges the native language knowledge of the learner 208 and, gradually, the toy 202 starts interacting with the learner in a second language previously selected by the user through mobile device 210. Teaching of the second language is carried out according to a pre-stored curriculum saved in whole (in some embodiments) or in part (in other embodiments) in memory onboard the toy 208. The toy 208 begins the second language instruction by exposing the learner 208 to sounds and syllables in the second language. To make learning process more personalized, the toy 202 includes with an artificial intelligence engine (not shown).

Further, the learning process is carefully examined and stored in the toy 202. This allows the system and interested parties (e.g., users, the learner, etc.) to evaluate and review the level/phase of the learner's learning 208. The pre-stored curriculum is continuously, periodically, or regularly updated with, for example, additional vocabulary from the server 212 in order to make learning more personalized. The server 212 is connected to the toy 202 through any wireless communication system, such as Local Area Network (LAN) or a Wide Area Network (WAN), including the Internet. The updated repository (i.e., language database) is stored in a local memory unit 308 of the toy 202, which can help functioning of the toy 202 in the absence of an Internet connection or communication with the server 212. In alternate embodiments, the language database is stored in the server 212. Necessary data can be transferred from the server 212 to the processor (or associated memory) onboard the toy 202 when called.

Furthermore, in the embodiment depicted in FIG. 2, the toy 202 is in communication with the mobile device 210, which is configured to control the toy 202. The learning associated app running on the mobile device preferably requires creating a user profile though which the toy 202 setting can be controlled. The settings include native language preference, preferred second language, etc.

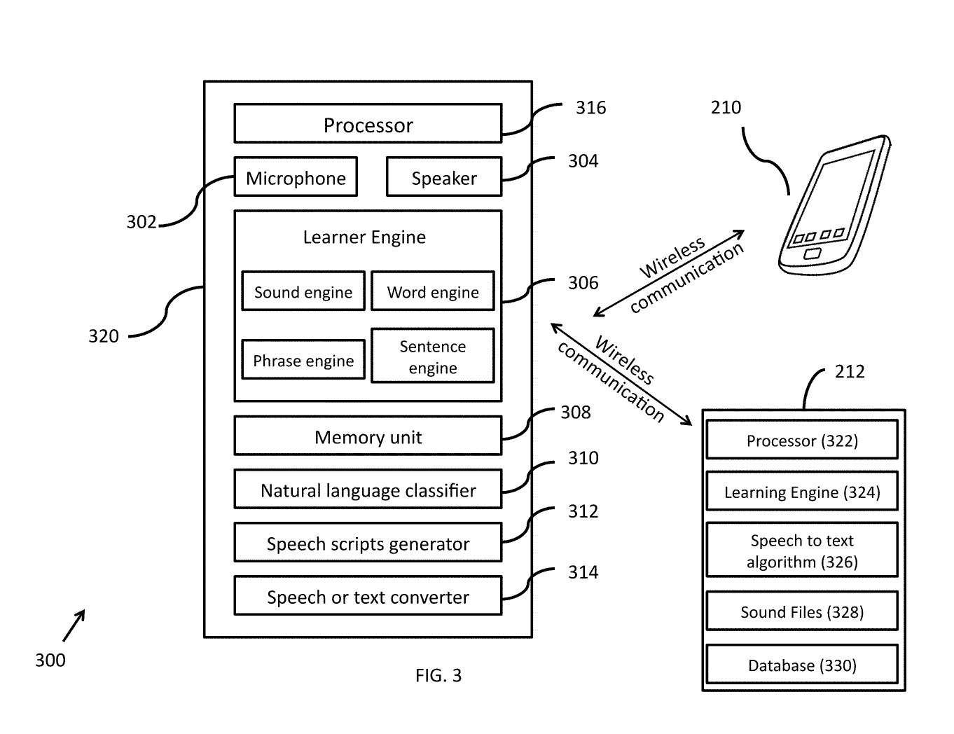

FIG. 3 illustrates a representative embodiment of the system of the invention 300. This drawing depicts certain of the components of the interactive unit 320, server 212, and user device 210. The interactive unit includes a processor 316 that drives the interactive unit 320 and processes instructions from software stored in the memory unit 308 and input from the learner and generates desired outputs. A microphone 302 is located on the unit 320 to acquire audio input from the learner as well as a speaker 304 to generate audio output intended for the learner.

Initially, the interactive unit 320 selects a native language (per a preset user preference) and starts interacting to the learner with the help of microphone 302 and speaker 304. Speech from the learner is converted to text through speech to text converter 314 and processed further. Natural language classifier software 310, embedded on to the unit 320, allows the unit to understand the native language in all appropriate contexts and to generate dialogue automatically that is then output to the learner, here, via the speaker 304. A representative example of such software 310 is IBM's Watson natural language classifier, which uses machine-learning algorithms to understand the language by relating to predefined classes for any given input. The software 310 generates output in the text format with the help of speech generator 312, which is then sent to a text to speech converter 314. Audible speech is then output to the learner through the speaker 304. Speaker volume may be adjusted or set via the mobile device 210, although in some embodiments it may be adjusted directly using a control on the interactive unit 320.

Gradually, the interactive unit 320 starts interacting with the learner in a second language as per a user-defined preference. A learner engine 306 helps the learner to learn the new language through specified stages. Initially, sounds and syllables are introduced to the learner with the help of a sound engine and then gradually words are introduced through a word engine. As the learner's proficiency improves, combinations of words then taught through a phrase engine, and then sentences are taught through a sentence engine.

In this embodiment, a server 212 is in communication with the interactive unit 320 to continuously update the learning curriculum for the second language. The learning curriculum is stored in a local memory unit 308, which facilitates the unit's Internet connection/communication with the server and, in turn, can be used to build an offline decision tree.

The server 212 includes a processor 322 and further includes a learning engine 324 that has responsibility for updating the learner engine 306 language curriculum used by the interactive unit 320. The server includes a speech to text algorithm 326, the data from which is used by the speech/text converter 314 on the learner side to covert speech to text or vice versa. The server 212 also includes data for sound files 328 and a SQL database designed for managing data held in a relational database management system; alternatively, speech-related data may be stream processed by relational database management portions of the system. As will be appreciated, any other standard interactive and programming languages known in the art or developed in the future could also be used instead for getting information from or updating the database.

Further, a user device 210, for example, a smart phone, is in communication with the interactive unit 320. The user device 210 is mainly used to control the interactive unit 320. Preferably, the user device presents a dash board (not shown in the fig) to the user (e.g., a parent or guardian of the learner), giving user the access to select, for example, the learner's native language, the new language to be learned, the desired pace of learning, output settings and levels, etc. Once the user installs or registers with the learning program by creating an individual user profile, s/he can control the interactive unit 320 via the mobile device 210.

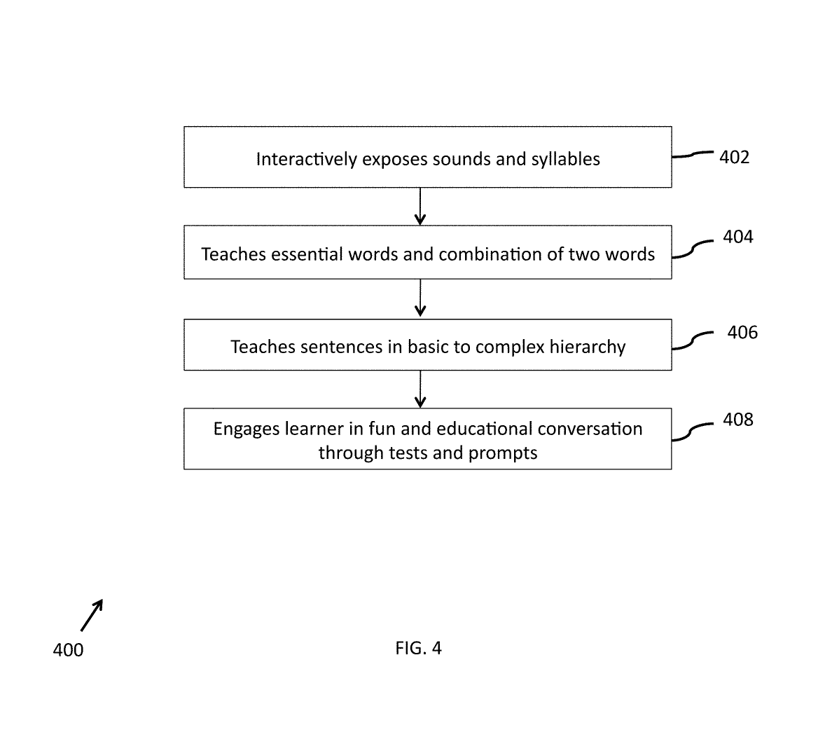

FIG. 4 is an illustrative embodiment of a flow diagram 400 that depicts the various steps involved in learning a new language in accordance with the invention. Initially the interactive unit/toy exposes the learner to sounds of the language to be learned. Once the sounds are familiar to the learner, the toy moves forward to introduce syllables 402. The process may include exposing the learner to vowels, consonants, affixes, diphthongs, rhyming, clusters, contrasts, and differentiation of both the native language and the new language, which helps the learner to compare and better remember the new language. The toy further teaches the learner to pronounce words and combinations of words 404 in the second language. Words with similar sounds and rhymes can be highlighted, as these will help the learner to remember the words in an easier way. These words are mainly concerned to basic vocabulary, social words, early pronouns, verbs/action words, negations, adjectives, adverbs, prepositions/locations, etc. Sentences are taught later, including simple basic phrases to complex sentences 406. Activities during this phase involve formation of sentences and imparting basic grammatical knowledge in the second language. These can be taught, for example, by interactions such as story telling, oral mimicry, encouragement, actions, and songs. Lastly, the toy engages the learner in fun and educational conversation through tests, prompts, question, answers, and tasks boosts the speaking ability of the learner.

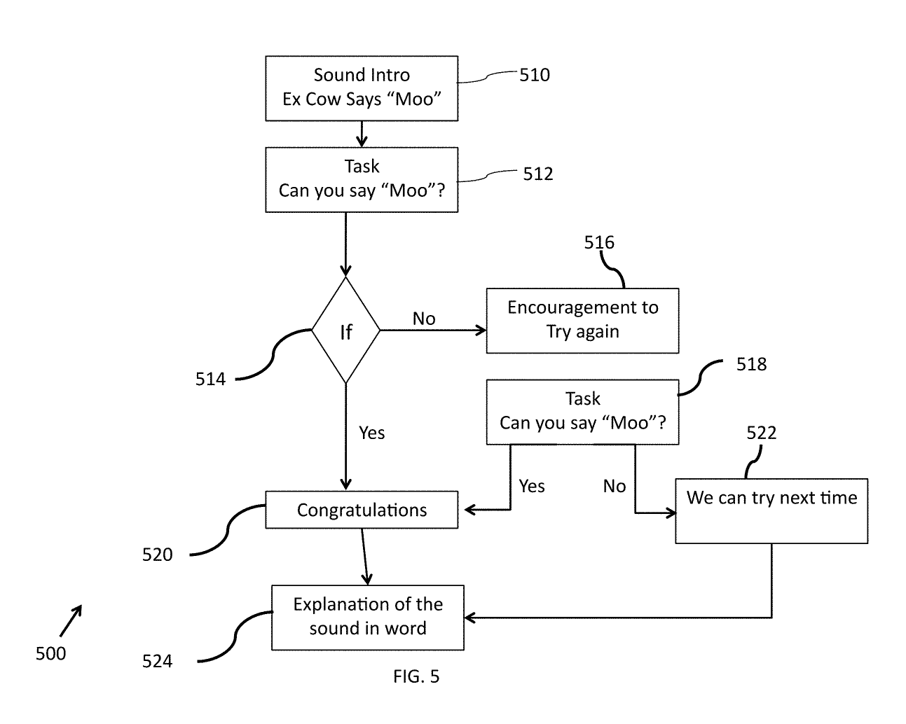

FIG. 5 is an exemplary embodiment that depicts the flow of conversation 500 of an interactive unit according to the invention. For example, the interactive unit/toy says “Cow says moo” (510) and then queries the learner/child for a response, such as “Moo” (512). If (514) the child says “Moo”, the toy congratulates the learner (520), for example, using an audio response generated by the speech generating components of the system. The reward can also include an explanation of the meaning of the word (524). If the child's response is something else, the interactive unit encourages the child to try again (516) by asking the child, for example, to say “Moo” (518). If the child succeeds at that point, the interactive unit congratulates the child (520). If not, the interactive unit asks the child to try next time (522) and then moves on to the explanation of the word 524.

As is apparent from the descriptions above, this invention will be of great assistance to people of all ages wishing to learn a new language, and especially so for young children, including developing strong vocabulary and grammatical skills.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

### Systems

Those skilled in the art will appreciate that in some embodiments of the invention, the functional modules of software implementation, as well as the personal and the integrated communication devices, may be implemented as pre-programmed hardware or firmware elements (e.g., application specific integrated circuits (ASICs), electrically erasable programmable read-only memories (EEPROMs), etc.), or other related components. Mobile communication devices that can use the present invention may include but are not limited to any of the “smart” phones or tablet computers equipped with digital displays, wireless communication connection capabilities such as iPhones and iPads available from Apple, Inc., as well as communication devices configured with the Android operating system available from Google, Inc. In addition, it is anticipated the new communication devices and operating systems will become available as more capable replacements of the forgoing listed communication devices, and these may use the present invention as well.

In other embodiments, the functional modules of the software of the invention can be implemented by an arithmetic and logic unit (ALU) having access to a code memory that holds program instructions for the operation of the ALU. The program instructions could be stored on a medium that is fixed, tangible and readable directly by the processor (e.g., removable diskette, CD-ROM, ROM, or fixed disk), or the program instructions could be stored remotely but transmittable to the processor via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The program instructions stored in the code memory can be compiled from a high level program written in a number of programming languages for use with many computer architectures or operating systems. For example, the high level program may be written in assembly language such as that suitable for use with a pixel shader, while other versions may be written in a procedural programming language (e.g., “C”) or an object oriented programming language (e.g., “C++” or “JAVA”).

In other embodiments, cloud computing may be implemented on a web-hosted machine or a virtual machine. A web host can have anywhere from one to several thousand computers (machines) that run Web hosting software, such as Apache, OS X Server, or Windows Server. A virtual machine (VM) is an environment, usually a program or operating system, which does not physically exist but is created within another environment (e.g., Java runtime). In this context, a VM is called a “guest” while the environment it runs within is called a “host”. Virtual machines are often created to execute an instruction set different than that of the host environment. One host environment can often run multiple VMs at once.

As disclosed herein, features consistent with the present invention may be implemented via computer-hardware, software, and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

### Machine Learning

In certain embodiments of the invention, the system that includes the server and/or data storage use various aspects of machine learning and analytics in order to make decisions regarding which learner-related educational or learning information and data to use for teaching a foreign or non-native language to a learner. For example, the system may utilize machine-learning protocols that are used to generate heuristics and predictions based on known properties learned from training data. The software and systems of the invention may implement supervised learning protocols, unsupervised learning, semi-supervised learning protocols, transduction protocols, etc. using example inputs and their desired outputs, given by a “teacher”, with the goal to learn a general rule that maps inputs to outputs.

A “teacher” may be a human domain expert who uses a decision-making system to determine outcomes given specific inputs. For example, in the casino gaming industry, human experts are used to plan a gaming layout based on varied inputs like expected clientele, location of in casino restaurants, casino entertainment and time of year. In this example, the inputs are too varied for a machine alone to make decisions so a teacher is needed to provide a base set of rules by which to begin making decisions. In an analogous way, the systems of the invention can be configured to dynamically generate the one or more analytics responsive to received student learning information associated with defined events (or other defined inputs) to classify student information using machine-learning protocols employing one or more classifiers. Non-limiting examples of classifiers include Bayesian networks, decision trees, Gaussian process classifiers, k-Nearest Neighbors (k-NN), LASSO, linear classifiers, logistic regression, multi-layer perceptron, naive bayes, radial basis function (RBF) networks, etc.

In some cases, machine learning operates on unlabeled examples, i.e., input where the desired output is unknown. In an example of such an instance, an objective may be to discover structure in the data, not to generalize mapping from inputs to outputs. Machine learning approaches can then be used to combine both labeled and unlabeled examples to generate an appropriate function or classifier for the event (or other input) and student learning data collected. Transduction and/or transductive inferences may be used to try to predict new outputs on specific and fixed (test) cases from observed, specific (training) cases.

Certain examples can be used to partition certain student learning information into the one or more information subsets using one or more machine-learning toolboxes. Non-limiting examples of machine-learning toolboxes include dlib kernels, efficient learning, large-scale inference, and optimization (Elefant), java-ml, kernel-based machine learning lab (kernlab), mlpy, Nieme, Orange (University of Ljubljana), pybrain (Python), pyML (Python), SciKit.Learn (Python), Shogun, torch7, Waikato Environment for Knowledge Analysis (Weka), and the like.

The system may partition student-learning information into the one or more information subsets using a spectral learning protocol electronically determining a rate of deviation from threshold condition. The systems may be used to partition the a learner's learning information into the one or more information subsets using one or more of built-in model selection strategies, classification, domain adaptation, image processing, large scale learning, multiclass classification, multitask learning, normalization, one class classification, parallelized code, performance measures, pre-processing, regression, semi-supervised learning, serialization, structured output learning, test framework, and/or visualization. Further, systems may be used to generate the one or more analytics responsive to received student learning information associated with the particular event (or other input) to partition the student learning information into the one or more information subsets using a clustering protocol and generate the one or more analytics responsive to received student learning information associated with, for example, a browser event related to student learning.

Unless the context clearly requires otherwise, throughout the description above and the appended claims, the words “comprise,” “comprising,” and the like are to be construed in an inclusive sense as opposed to an exclusive or exhaustive sense; that is to say, in a sense of “including, but not limited to”. Words using the singular or plural number also include the plural or singular number, respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list, and any combination of the items in the list.

The foregoing description, for purpose of explanation, has been described with reference to specific embodiments. However, the illustrative discussions above are not intended to be exhaustive or to limit the invention to the precise forms disclosed. Many modifications and variations are possible in view of the above descriptions. The embodiments were chosen and described in order to best explain the principles of the invention and its practical applications to thereby enable others skilled in the art to best utilize the invention and various embodiments with various modifications as are suited to the particular use contemplated. As such, the invention extends to all functionally equivalent structures, methods, and uses, such as are within the scope of the appended claims, and it is intended that the invention be limited only to the extent required by the applicable rules of law.

What is claimed:

1. An interactive system for language learning, comprising:
a. an interactive unit configured to converse multilingually, the interactive unit comprising a processor configured to take instructions from a learner engine, a speaker, a microphone, and a power supply, and optionally one or more of a display and a light source;
b. a server in contact with the interactive unit; and
c. a user device configured to control the interactive unit, which user device optionally is integrated into the interactive unit.

2. An interactive system according to claim 1, wherein the interactive unit is a toy.

3. An interactive system according to claim 1, wherein the user device is a mobile device, optionally an Android device, an iOS device, or a Windows device.

4. An interactive system according to claim 1, wherein the interactive unit further comprises at least one of the following:
(a) a plurality of speakers;
(b) a second microphone; and
(c) a memory unit.

5. An interactive system according to claim 1, wherein the learner engine further includes one or more of a sound engine, a word engine, a phrase engine, and/or a sentence engine.

6. An interactive system according to claim 1, wherein the learner engine is configured to decide the difficulty level of interaction with the learner.

7. An interactive system according to claim 1, wherein the interactive unit further includes a natural language classifying unit.

8. An interactive system according to claim 1, wherein the interactive unit is wirelessly connected to the server.

9. An interactive system according to claim 1, wherein the server includes learning software.

10. An interactive method for language learning, the method comprising:
conversing in at least one native language of a learner by an interactive unit according to claim 1;
selecting a second language to be taught to the learner by the interactive unit;
using the interactive unit to converse with the learner in the selected second language;
communicating with a server configured to update the interactive unit; and
receiving instructions from a user device configured to control the interactive unit.

11. An interactive method according to claim 10 wherein, the interactive unit is a toy.

12. An interactive method according to claim 10 wherein, the learner is exposed to sounds of the second language, words of the second language, phrases of the second language, and/or sentences of the second language.

13. An interactive method according to claim 10 wherein, the user device is a mobile device, optionally an Android device, an iOS device, or a Windows device.

14. An interactive method according to claim 10 wherein, the mobile device is further configured to create a user profile, to set language preferences, and/or to set pace of learning.

15. An interactive method according to claim 10, wherein the interactive unit further comprises at least one of the following:
(d) a plurality of speakers;
(e) a second microphone; and
(f) a memory unit.
